(19) United States
(12) Patent Application Publication
(10) Pub. No.: US 2006/0098937 A1
(43) Pub. Date: May 11, 2006

(54) Method and apparatus for handling layered media data

(75) Inventors: Wilhelmus Hendrikus Alfonsus Bruls, Eindhoven (NL); Albert Maria Arnold Rijckaert, Eindhoven (NL); Godert Willem Renswoud Leibrandt, Eindhoven (NL); Mark Jozef Willem Mertens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/539,971

(22) PCT Filed: Dec. 1, 2003
(86) PCT No.: PCT/IB03/05671

§ 371 Date: Jun. 19, 2005

(30) Foreign Application Priority Data
Dec. 20, 2002 (EP) 02080532.1

(51) Int. Cl. H04N 5/781

(52) U.S. Cl. 386/46; 386/125

(57) ABSTRACT

A method and apparatus (100) for handling a layered digital video stream, comprising a base layer stream and an enhancement layer stream for providing HDTV, is disclosed. Either of the base layer stream or the enhancement layer stream is stored on a hard disc (101), and the other is stored on an optical disc by means of an optical disc drive (102). The streams are handled separately until they are utilized for providing HDTV. When the layered video stream is to be played back with HDTV quality, the base layer stream and the enhancement layer stream are synchronized by means of a synchronizer (106) for referring to the same frame. The synchronized streams are then decoded by means of a base decoder (105a) and an enhancement decoder (105b), which outputs decoded streams that are combined by an adder 112.

This invention relates in general to the field of handling a media data stream, and more particularly to the field of handling a layered media data stream comprising a first media data stream and a second media data stream, which is associated with the first media data stream.

Because of the massive amounts of data inherent in digital media data, such as audio/video data, the transmission and storing of full-motion, high-definition video signals is a significant problem in the development of high-definition television (HDTV). More particularly, each digital image frame is a still image formed from an array of pixels according to the display resolution of a particular system. As a result, the amount of raw digital information included in high-resolution video sequences is massive. In order to reduce the amount of data that must be sent, compression schemes are used to compress the data. Various audio/video compression standards or processes have been established, including MPEG-2, MPEG-4, and H.264.

Many media data applications, such as digital audio/video, are enabled where media data is available at various resolutions and/or qualities in different layers. Methods to accomplish this are loosely referred to as scalable techniques. There are three axes on which one can deploy scalability. The first is scalability on the time axis, often referred to as temporal scalability. Secondly there is scalability on the quality axis, often referred to as signal-to-noise scalability or fine grain scalability. The third axis is the resolution axis (number of pixels in image), often referred to as spatial scalability or layered coding. In layered coding, the bit stream is divided into two or more associated bit streams, or layers. Each layer can be combined to form a single high resolution signal. For example, the base layer may provide a lower quality media data signal, while the enhancement layer provides additional information that can enhance the resolution of the base layer image.

In particular, spatial scalability can provide compatibility between different audio/video standards or capabilities. With spatial scalability, the base layer may have a lower resolution than the input audio/video sequence, in which case the enhancement layer carries information which can restore the resolution of the base layer to the input sequence layer.

Apparatuses for rendering and/or recording media data, such as a DVD (Digital Video Disc) player or a set top box (STB), comprises often times both a hard disc drive (HDD) having a hard disc and an optical disc drive (ODD) for recording on/reading from removable optical discs, such as DVD, DVD+R, and DVD+RW. Media data downloaded from a remote source over a wireless or wire based transmission channel, such as the Internet or a cable television network, or broadcasted via a terrestrial broadcasting system can be stored on the HDD or recorded on a DVD. Then, the stored content can be retrieved from the HDD or the DVD for rendering at a later time.

The capacity of the HDD in a media data apparatus, such as a DVD recorder or STB, and the capacity of memories in other equipment, such as a portable radio, a mobile telephone, or a car radio, is limited. For a HDD in such an apparatus the hard disc will in coming years usually not exceed 50-100 Gbytes, i.e. about 10-20 hours video with HDTV quality (assuming average 10 Mbits/s). This is sufficient for time shift recording but insufficient to contain an entire video archive. In a media data apparatus having a HDD/optical disc drive combination, media data may be archived on optical discs, or read from optical discs, which greatly reduces the accessibility of the video-archive, e.g. on-line browsing becomes impossible.

Owners of apparatuses having a HDD/optical disc combination may want to copy content that is recorded on the hard disc onto removable optical discs for at least two reasons:
1.) For archiving purposes, typically this is the content that will be rendered on the same apparatus.
2.) For sharing purposes, i.e. content that is intended to be viewed on a different apparatus.

Content providers and content owners may be reluctant to allow copying of content from the HDD to optical discs; as long as the content is only on the HDD the content can be controlled and through copy protection and/or conditional access schemes it can be made sure that the content is not unauthorized copied and distributed in an uncontrolled fashion. However, for archiving purposes, there is no principle objection, as the intent is not further distribution, but a secure mechanism is needed to avoid that the archived content can be viewed in different apparatuses after all. With respect to sharing purposes, it may in some cases be in the interest of the broadcasters and/or content providers to not ban this altogether, but allow making copies, which do not carry the full experience as provided by the original content on the HDD.

It may also be in the interest of the provider of media data to restrict use of the base layer unconditionally, and use of the enhancement layer conditionally, wherein the use of the enhancement layer is restricted to rendering a certain number of times or during a certain time period. When the time period has lapsed, or the number of times are used up, the enhancement layer stream and/or the base layer stream may be deleted from the memory wherein they are stored. However, if the layered stream is handled together, this is not possible.

Content broadcasted or distributed over a network requires a certain bandwidth, such as when broadcasted to a portable radio, a mobile telephone and a car radio. However, layered media data may be too extensive to broadcast over a channel having limited bandwidth with the high quality resolution, or the storage space of the memory may be limited. Therefore, only the low-resolution media data is transmitted to the apparatus. This is a problem if the viewers or listeners prefer a high-resolution experience.

The present invention overcomes the above-identified deficiencies in the art and solves the above problems by providing methods, and apparatuses, and a computer readable program according to the appended independent claims.

The general solution according to the invention is to handle a first media data stream and a second media data stream comprising information for enhancing the resolution of the first media data stream separately until the second media data stream is utilized for the enhancing.

More particularly, according to one embodiment the first media data stream is a base layer stream and the second media data stream is an enhancement layer stream for enhancing the resolution of the first media data stream. Both streams are handled separately until they are utilized for providing a media data stream having enhanced resolution, such as a HDTV stream.

According to one aspect of the invention, a method is provided for handling the first and second media data streams separately. The first and second media data streams are retrieved from at least one medium, such as received in a transmission stream received as a signal over the Internet, or received over different channels of a transmission medium. The data of the media data streams are then stored on separate media, such as a hard disc and an optical disc.

According to another aspect of the invention, the method provides the possibility to render a media data stream with high definition resolution, wherein the first media data stream is obtained from a first medium, such as a hard disc or a first channel of a transmission medium. The second media data stream is obtained from a second medium, such as an optical disc or a second channel of the transmission medium other than the first medium. Then the streams are decoded and synchronized to refer to the same frame or sequence for providing the media data having high resolution.

According to yet another aspect of the invention, an apparatus for handling the media data stream separately is provided. The apparatus is configured to store the media data streams on separate media. The apparatus comprising means for acquiring the first media data stream, means for acquiring the second media data stream, said apparatus being configured to handle the first and the second media data streams separately until the second media data stream is utilized for enhancing the resolution of the first media data stream.

According to another aspect of the invention, an apparatus for retrieving a first and a second media data stream from separate media are provided. The apparatus is configured to synchronize the retrieved streams, decode the streams and combine the decoded streams into an enhanced media data stream.

According to a further aspect of the invention, a computer readable medium having embodied thereon a computer program for processing by a computer, such as a processor, is provided. The computer program comprises a code segment for carrying out the method according to the invention as recited in the independent method claim.

Preferred embodiments of the present invention will be described in the following detailed disclosure, reference being made to the accompanying drawings, in which

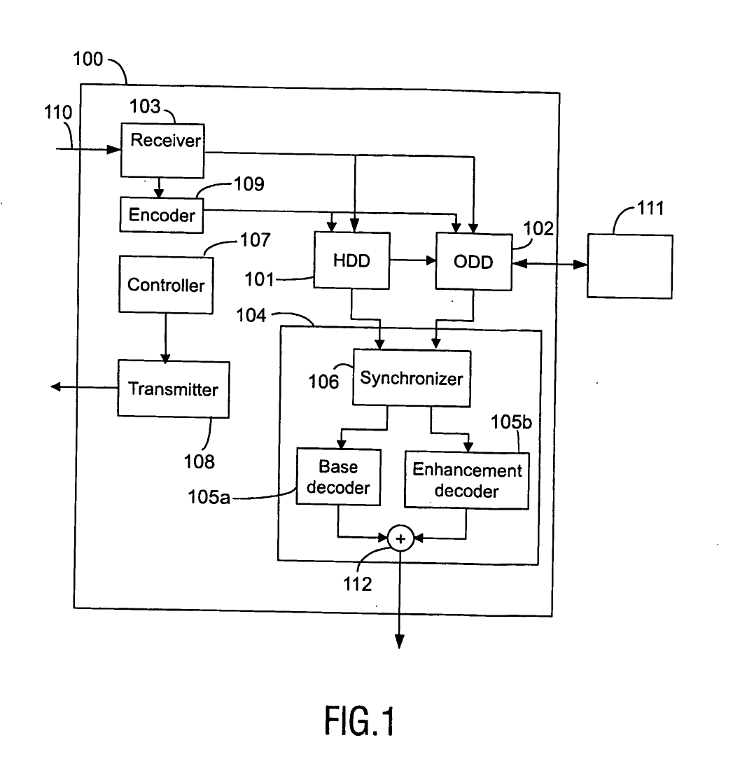

FIG. 1 is a block diagram of an apparatus according to one embodiment of the invention, comprising a hard disc drive/optical disc drive combination;

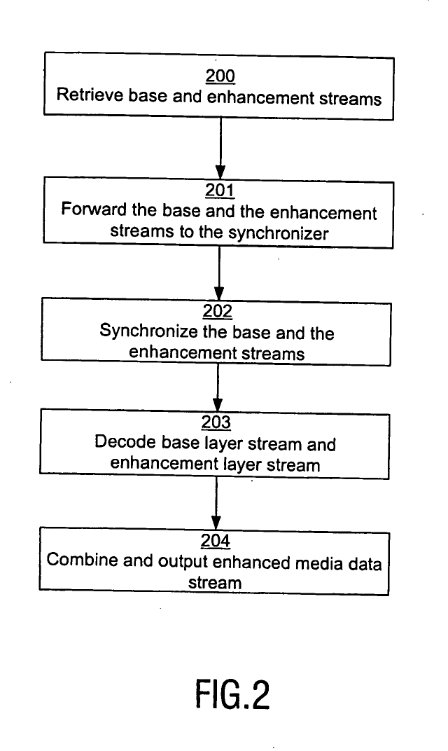

FIG. 2 is a flow chart of one embodiment of a method according to the invention;

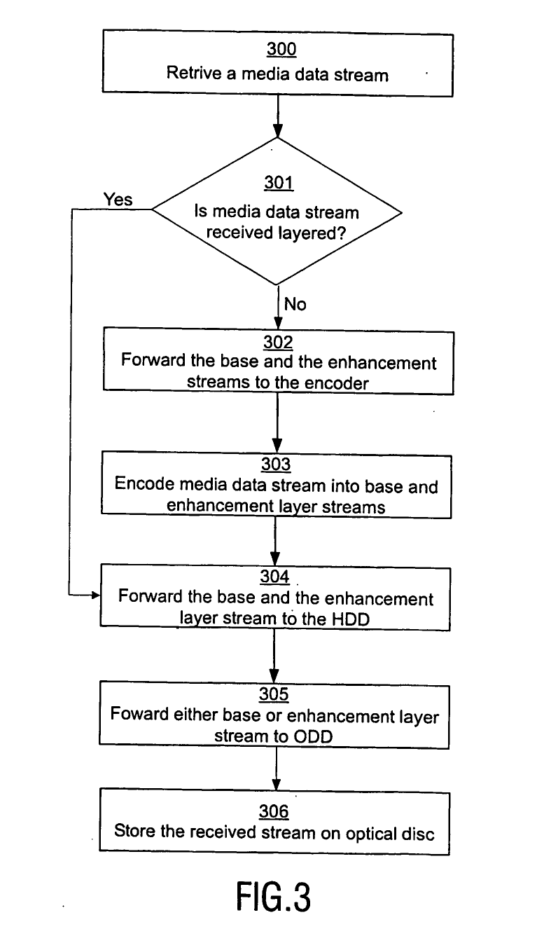

FIG. 3 is a flow chart of another embodiment of a method according to the invention;

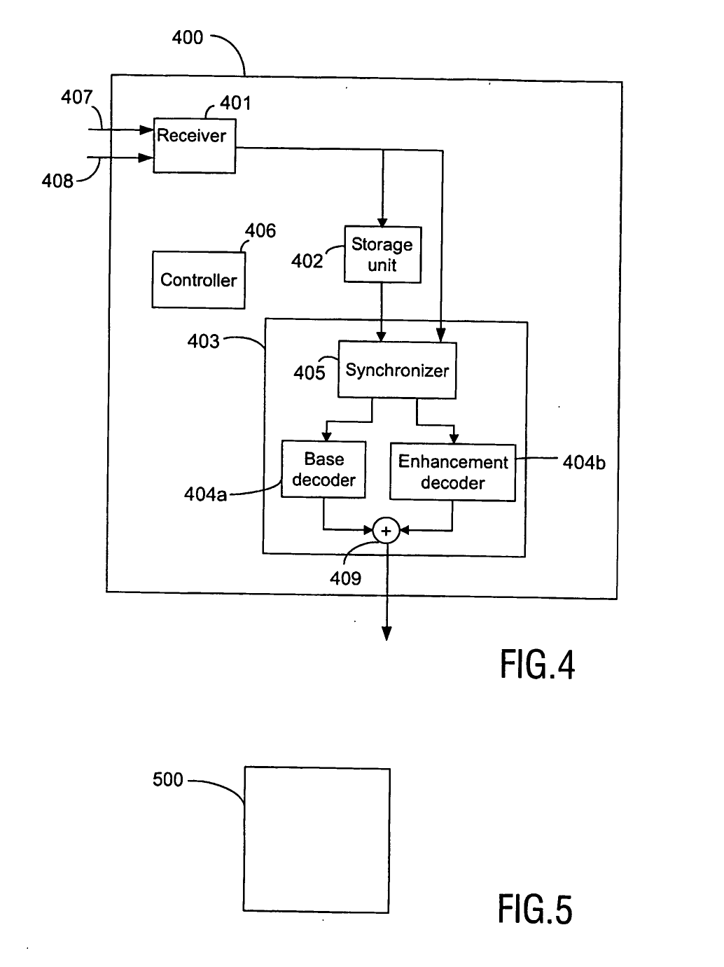

FIG. 4 is a block diagram of an apparatus according to a further embodiment of the invention; and

FIG. 5 illustrates a computer readable program.

In a preferred embodiment of the invention a method is provided, according to which a first media data stream, such as a base layer stream, and a second media data stream, such as an enhancement layer stream, having information related to the first media data stream, are handled separately. The media data streams are in the preferred embodiment digital audio/video data provided as a bit stream encoded using a compression technique, such as MPEG-2, MPEG-4, or H.264. However, in an alternative embodiment the method according to the invention is utilized in digital broadcasting and/or content providing techniques, wherein the resolution of a first media data stream is enhanced using the second media data stream, such as in digital radio.

FIG. 1 is a block diagram of a set top box (STB) 100 according to one embodiment of the invention. The STB comprises a combination of writable and/or readable memories, in this embodiment a HDD 101 and an optical disc drive (ODD) 102 for writing to and/or reading from an optical disc. The term HDD when used in this specification means a hard disc drive comprising a hard disc, if not otherwise stated. The HDD 101 and the ODD 102 are configured to handle layered media data, such as digital high definition television (HDTV) data comprising a base layer and an enhancement layer. Further, the STB 100 comprises a receiver 103 connected to the HDD 101 and the ODD 102 for acquiring media data over a wireless transmission medium, such as a satellite or terrestrial interface for broadcasting digital audio/video data. Alternatively or additionally, the receiver 103 may be configured to retrieve layered media data over a wire-based transmission medium, such as the Internet or a cable television network. The STB 100 also comprises a decoder 104 having a base decoder 105a and an enhancement decoder 105b, which are connected to a preceding synchronizer 106 being configured to synchronize data of the base layer stream and data of the enhancement layer stream before said streams are decoded. Also, the base decoder 105a and the enhancement decoder 105b are operatively connected to an combiner 112 configured to add the decoded stream to a combined media data stream. A controller 107, such as a central processing unit (CPU) or microcontroller, is provided to control the overall operation of the STB 100 as well as to control the operation of specific components of the STB 100. For ease of illustration, each connection of the controller 107 is not illustrated in FIG. 1. Also illustrated in FIG. 1 but not being part of the STB 100 is a signal 110 which carries information for the first and the second media data streams, and an optical disc 111, which the ODD can store on/retrieve from a media data stream. As is appreciated, the invention is not limited to a STB 100, which is only disclosed for illustrating purposes. The scope of the invention includes any apparatus, such as a DVD recorder comprising a hard disc drive HDD, having functionality for carrying out the method according to the invention, as will be explained in the following.

In an alternative embodiment, the STB 100 illustrated in FIG. 1 comprises a transmitter 108 connected to the controller 107, said transmitter 108 being configured to transmit messages to a content provider, e.g. to validate that the STB 100 is authorized to render a specific content.

In still another embodiment of the invention, the receiver will receive a media data stream, which is not layered when received. Therefore, the received media data stream will be forwarded to an encoder 109, which is configured to encode the media data stream to a base layer stream and an enhancement layer stream according to a compression technique for providing spatial scalability, which each will be forwarded to either the HDD 101 or the ODD 102. In an alternative embodiment, the encoder 109 is provided as a transcoder.

According to one embodiment of the invention, the STB 100 is capable of handling at least two layers of a layered media data stream separately for either storing a first media data layer stream, such as a base layer stream, on a first memory, e.g. the HDD 101, and a second media data stream, such as an enhancement layer stream, on a separate memory, e.g. on the optical disc 111 by means of the ODD 102. Alternatively or additionally, the STB 100 is capable of acquiring a first media data stream from a first medium, such as the signal 110, and acquiring the related second media data stream from a second medium, such as the HDD 1101 or the optical disc 111.

In one embodiment, the base layer is provided on a first memory, such as a DVD, which e.g. is bought in a shop. The enhancement layer for improving the quality of the base layer is provided via a second medium, such as the Internet or a signal broadcasted over a transmission channel. The provider of the enhancement layer may restrict the use of the enhancement layer for a certain period of time, or a certain number of times, such as once or twice, depending on the amount of money paid.

In an alternative embodiment, all media data, i.e. both the base layer stream and the associated enhancement layer stream, is received by the receiver 103 and stored on the HDD 101. According to the invention, the base layer and the enhancement layer may be stored on separate memories, such as:

1.) The base layer is stored on the HDD 101, and the enhancement layer is transmitted to the ODD 102, which will write the enhancement media data stream onto a writable optical disc, such as a DVD+R or DVD+RW. In this case, the media data archive is stored in base quality on the HDD 101, which is directly accessible by the controller 107 for searches and references. The base layer stream may be played back without the enhancement layer stream. However, if it is preferred to view the content in high quality, the optical disc 111 containing the associated enhancement layer stream has to be inserted into the ODD 102. In this fashion, a 100 GB hard disc will be able to hold up to five times more video content than if the high quality content was stored on the HDD 101. Further, this also provides a copy protection mechanism, as the high quality content can only be viewed on an apparatus comprising the base layer associated with the enhancement layer. The enhancement layer loaded onto the optical disc 111 is useless without the base layer.

2.) The enhancement layer stream is stored on the HDD 101, and the base layer stream is off-loaded from the HDD 101 to the optical disc 111. In this case, the base layer stream is available on the optical disc 111 for sharing between different apparatuses. However, experiencing the high quality media data stream will be restricted to the STB 100, wherein the enhancement layer is stored. This provides a security protection for the enhancement layer stream. Also, in this case the enhancement layer stream may be restricted to conditional use, wherein the enhancement layer has to be validated before use, e.g. by checking the validity of a time stamp or a certificate.

The base layer stream retrieved from a first medium, e.g. either from the optical disc 111 by means of the ODD 102 or from the HDD 101, may be rendered without the enhancement layer stream with low quality. The base layer stream is provided to the base decoder 105a decoding the coded base layer stream. Then, the base decoder 105a will generate a media data stream having low quality when rendered on a display.

FIG. 2 is a flow chart of the steps carried out according to one embodiment of the invention for handling the first and second media data streams for providing a decoded media data stream having high quality. In a first step 200, the enhancement layer stream is retrieved from a first storage medium, e.g. either from the HDD 101 or the optical disc 111 by means of the ODD 102. Also, the associated base layer stream is retrieved from a separate second medium other than the medium of the enhancement layer, such as either the HDD 101 or the optical disc 111 by means of the ODD 102. The encoded enhancement layer and base layer are in step 201 provided to the synchronizer 106, which in step 202 makes sure that the information of both streams refer to the same frame when forwarded to the decoders, which is further discussed below. Then, in step 203 the enhancement layer stream is forwarded to the enhancement decoder 105b, and the base layer stream is forwarded to the base decoder 105a, wherein both the base layer stream and the enhancement layer stream will be decoded. Finally, in step 204 a decoded enhanced media data stream having high quality is provided by the combiner 112 by combining the decoded base layer stream and the decoded enhancement layer stream, which may be rendered on a display.

FIG. 3 is a flowchart of the steps carried out according to an alternative embodiment of the invention. In a first step 300, a media data stream is retrieved, e.g. received over a transmission channel. In step 301 it is decided whether the media data stream was received in a layered fashion. If the answer in step 301 is negative the media data stream is in step 302 forwarded to the encoder 109, which in step 303 will encode the media data stream into a base layer stream and an enhancement layer stream. The encoded base layer stream and enhancement layer streams are then forwarded to the HDD 101 in step 304 for storing. However, if the media data stream is received in a layered fashion, i.e. if the answer in step 301 is affirmative, the procedure continues in step 304. Finally, either the enhancement layer stream or the base layer stream is in step 305 forwarded to the ODD 102, which in step 306 will store the received stream on the optical disc 111. Alternatively, either the enhancement layer stream or the base layer stream is in step 304 directly forwarded to the ODD 102 without temporarily storing it on the HDD 101.

FIG. 4 is a block diagram of an alternative embodiment of an apparatus 400 according to the invention for receiving a digital layered media data stream comprising at least a first media data stream, such as a base layer stream, and a second media data stream, such as an enhancement layer stream, associated with the first media data stream. The apparatus 400 may e.g. be embodied as a portable radio, a mobile telephone, or a car radio. The apparatus comprises a receiver 401 configured to receive digital encoded data packets broadcasted over e.g. a wireless interface, such as digital radio received over first and second channels. Further, the apparatus 400 comprises a storage unit 402, for storing e.g. on a removable optical disc, or an internal solid state memory. Further, the apparatus 400 comprises a decoder 403 having a base decoder 404a and an enhancement decoder 404b, each capable of decoding data packets encoded using spatial scalable encoding techniques, such as MPEG-2, MPEG-4, or H.264. Also, the apparatus 400 comprises a synchronizer 405 provided prior to and connected to the decoders 404a, 404b, configured to synchronize data of the base layer stream and the enhancement layer stream, wherein information from the base layer stream and the enhancement layer stream refer to the same part of a content when fed to the decoders. Also, an combiner 409 is connected to the base decoder 404a and to the enhancement decoder 404b, said combiner 409 being configured to combine the decoded base layer stream and enhancement layer stream. For controlling the overall operation of the apparatus 401, a controller 406, such as a CPU, is connected to each of the other components described. However, in FIG. 4 all connections of the controller 406 are not shown for ease of illustration. Also, illustrated in FIG. 4 is a first and second signal 407, 408, which are received over different channels over a wireless or wire-based transmission medium. The signals carry information for the first and second media data streams, respectively.

According to one embodiment of the invention, a first media data stream is obtained from a first medium, e.g. received by means of the receiver 401 over a first channel of a transmission medium, such as a first AM/MW (Amplitude Modulated/Medium Wave) channel. Also, a second media data stream is obtained from a second medium, e.g. received by means of the receiver 401 over a second channel of the transmission interface. The first and second media data streams are in some sense associated or interrelated. The first media data stream may e.g. comprise a base layer stream, and the second media data stream may e.g. comprise an enhancement layer stream for improving the quality of the first media data stream.

In another embodiment, the first media data stream comprises high quality audio data for rendering a song, which not only is played back, but also stored on the storage unit 402. The second media data stream may e.g. be a talk show broadcasted over a channel having low quality. Then, if a song appears in the talk show that has been received over a high-quality channel previously, the controller 406 can check whether the specific song is stored in the storage unit 402, and if so the stored song is prioritized over the part of media data comprising the same song transmitted over the low-quality channel. The stored song is then retrieved, in stead of the corresponding received song, from the storage unit 402, synchronized by means of the synchronizer 405 and decoded by means of the decoders 403, 404. The number of songs stored in the storage unit 402 depends on its storage capacity. The number of songs can for example be limited to the 100 most popular songs appearing on a hit list. For identifying a specific song, each song has to be provided with an identifier, such as an identifier in e.g. RDS. In alternative to storing the high-quality song on the storage unit 402, only enhancement layer data of that song is stored on the storage unit 402. Then, the enhancement layer data is combined with an associated base layer stream of that song contained in e.g. a talk show transmitted over a low-quality channel.

The base layer stream and the enhancement layer streams are, as indicated previously, synchronized, wherein the synchronizer 106 combines the information into the same frame or audio sequence. According to one embodiment of the invention the synchronization is achieved by using either time stamps per frame, which e.g. are mandatory in MPEG-2, or by using frame numbers. The time stamps will work in all cases. However, care must be given to the use of frame numbers when e.g. the frame rate of base layer and enhancement layer are different to make sure that decoded base layer and enhancement layer frames correspond to each other. That is, if e.g. the frame rate is different, such as base layer is at 15 frames per second, enhancement layer is at 60 frames per second, wherein frame number 1 of the base stream corresponds to frame number 1 of the enhancement stream, but base layer frame number 2 does not correspond to enhancement layer frame number 2, but correction is needed. Then the base layer frame number 1 matches enhancement layer frame number 1, but base layer frame number 2 matches enhancement layer frame number 5, etc. In an integral storage system, wherein the source of the first and second media data streams, such as the encoder 109, is in the same unit as the storage unit, such as the HDD 101 and ODD 102, with unencrypted data stored the frame numbers are sufficient. However, if the layered media data has to be transmitted over a digital interface or a broadcast channel between the storage device and the decoder, the frame numbers will not be sufficient. The storage device then has no way to know whether the playback back of both the base layer stream and the enhancement layer stream is sufficiently synchronized. In that case, the data must be sent over the digital interface or transmission channel as a transport stream. Packets of the base layer and enhancement layer can each be allocated their own PID (Packet IDentifier) number. Synchronization is now provided by adding time stamps to the transport stream packets of both streams, which the synchronizer can read to synchronize the streams. The time stamps are preferably coupled to the program clock reference (PCR) time base of the transport stream. The PCR time base is usually present in every transport stream. It is therefore preferred that both layers share the same transport stream. However, if this is not the case, e.g. when the enhancement layer is broadcasted separately, care must be taken that both streams have the same PCR time-base. As should be noticed, synchronization at the package level is no substitute for synchronization at the frame level, which remains necessary.

As indicated previously, conditional access (CA) rights can protect either of the layers. If separation in the base layer and the enhancement layer is provided by the broadcaster, and both layers are protected by CA rights, the two layers should each have their own PID number with coupled to that a PID number of the associated entitlement control numbers (ECMs), which contain the encrypted control words needed as keys to decrypt the media data streams. Separate ECMs can be utilized for each stream, wherein the base layer stream and the enhancement layer stream may have different conditional rights.

Applications and use of the above described layered media data streams according to the invention are various and include exemplary fields such as HDTV/SDTV (Standard Definition television) partitioning, wherein partitioning is chosen such that the base layer stream renders the video content at SD resolution (i.e. 480i at 60 Hz, or 576i at 50 Hz) and the enhancement layer stream enhances the video content to HDTV resolution (e.g. 1080i, or 720p). In another embodiment SDTV/CIF partitioning, which is similar to the previous embodiment, wherein the base layer stream now carries CIF information, and the enhancement layer stream carries SDTV surplus. Also, the enhancement data could e.g. be a color correction profile (only a few bits) provided via the Internet so that the video can be seen in full quality.

Other applications are related to a DVD player or a STB having a HDD and an ODD, wherein a first media data stream is stored on/retrieved from a first medium, such as either the HDD or the optical disc, and a second media data stream is stored on/retrieved from a second medium other than the first medium, such as either the HDD or the optical disc. Also, both streams can be retrieved from the same medium, such as the Internet. This provides the possibility to download content from e.g. the Internet, which can be used to enhance parts of or the whole base layer stream provided on the optical disc. The set top box could e.g. automatically scan video on demand sites to look for enhancement data to a movie, which will be shown on television (with SD quality) according to a digital program guide. Alternatively, one of the related media data streams can be downloaded on the optical disc, whereas the other is stored on the HDD. Alternatively, the base layer stream and the enhancement layer stream are retrieved from separated channels simultaneously.

Another application is in digital radio, wherein the quality of one transmission channel is low, and higher quality is preferred. A broadcasted first media data stream can be enhanced by means of a second media data stream containing data for improving the user experience of the first media data stream. E.g. in audio the second media data stream can comprise additional channels, such as e.g. low frequencies of a low frequency effect channel, or additional surround channels, which may be broadcasted independently of the first media data stream, preferably in advance, and stored in a memory.

Still another application for the invention is to provide a security mechanism for unauthorized copying, as discussed above. The STB could look for certain physical properties coming from the DVD basic engine (e.g. certain wobble information modulated on the original disc) for validating the DVD, which currently is not used by regular DVD players and discs. If the optical disc is bitcopied on e.g. a DVD+R, the wobble information is lost and will not play in the STB as HDTV even when the enhancement stream is available. Other data than wobble information, which are not allowed to be copied, can be used within the scope of the invention. Also, the STB or DVD recorder could detect that a DVD+RW, DVD+R, DVD-R, or DVD-RW is present, wherein the DVD is considered to be an unauthorized copy, which is refused to be played as HDTV.

In some embodiments of the current invention, the second media data stream contains extra samples, e.g. extra pixels for the sides of a video picture, to improve the perceived picture quality by making it of higher aspect ratio.

In other embodiments the second media data stream only contains some data—e.g. parameters of predefined functions or specifications of functions—, e.g. to describe a set of transformations to perform on the video or audio data of the first data stream to make it of higher perceived quality. An advantage of these embodiments is that the second data channel or storage can have smaller capacity, and if the content of the second media data stream has to be paid for in dependence of the number of received bits, in these embodiments increased quality is achieved for a low price.

E.g., the second media data file may only comprise model parameters: e.g. a color correction profile can be sent as data to be applied to a number of video pictures of the first media data stream. E.g. a night scene can be made more bluish for additional effect by matrixing the pixels with a color correction matrix.

It is also possible within the scope of the invention to provide filtering parameters or filter specifications in the second media data stream, to filter a set of pixels—e.g. the center of a video frame with a first filter, and the border regions with a second filter—of the first media data stream to increase the perceived resolution of the video picture. Alternatively, a model for providing a three-dimensional computer generated character can be provided in the second media data stream, which is utilized to be superimposed somewhere in the first media data stream.

The applied transformation can be different for different regions in the pictures, different objects in the pictures (e.g. in object oriented compressed video), etc. Very complex parametric operations can be described with fewer bits than required for the extra samples.

The method according to the invention can be comprised on a computer readable medium shown in FIG. 5, such as a register of the controllers 107, 406, having embodied thereon a computer program for processing by the controllers (107; 406). The computer program will in such a case comprise a code segment for carrying out the method, such as e.g. described in relation to the preferred and alternative embodiments described above.

The present invention has been described above with reference to specific embodiments. However, other embodiments than the preferred above are equally possible within the scope of the appended claims, e.g. different method steps than those described above, performing the above method by hardware or software, etc.

Furthermore, the term “comprising” does not exclude other elements or steps, the terms “a” and “an” do not exclude a plurality and a single processor or other unit may fulfil the functions of several of the units or circuits recited in the claims.

The invention may be summarised as a method and apparatus (100) for handling a layered digital video stream, comprising a base layer stream and an enhancement layer stream for providing HDTV, is disclosed. Either of the base layer stream or the enhancement layer stream is stored on a hard disc (1101), and the other is stored on an optical disc by means of an optical disc drive (102). The streams are handled separately until they are utilized for providing HDTV. When the layered video stream is to be played back with HDTV quality, the base layer stream and the enhancement layer stream are synchronized by means of a synchronizer (106) for referring to the same frame. The synchronized streams are then decoded by means of a base decoder (105a) and an enhancement decoder (105b), which outputs decoded streams that are combined by an adder 112.

In an alternative embodiment, the apparatus comprises processing means for processing an audio signal and/or a video signal.

1. A method for handling a first digital media data stream and a second digital media data stream having additional information related to the first media data stream, comprising the steps of:
retrieving media data for the first digital media data stream from a first medium; and
retrieving media data for the second media data stream from a second medium.

2. The method according to claim 1, wherein the first media data stream is a base layer stream and the second media data stream comprises information for improving the quality of the first media data stream, which streams are handled separately until the second media data stream is utilized for enhancing the resolution of the first media data stream.

3. The method according to claim 1, wherein the media data for the first media data stream is retrieved from a first memory, or retrieved from a signal carrying the first media data stream over a first channel of a wireless or wire based transmission medium; and the media data for the second media data stream is retrieved from a second memory, or retrieved from a signal carrying said second stream over a second channel of the wireless or wire based transmission medium.

4. The method according to claim 3, wherein
the first memory is an hard disc, or a solid state memory; and
the second memory is an optical disc, or vice versa.

5. The method according to claim 1, further comprising the step of:
checking the validity of a time restriction of at least one of the first and the second media data streams.

6. The method according to claim 1, wherein the step of handling further comprises the steps of:
determining whether any of the first or second media data streams are unauthorized copies by checking that data which are not allowed to be copied are present; and
prohibiting rendering of any unauthorized copied media data stream.

7. The method according to step 1, further comprising the step of:
synchronizing the first and the second media data streams using time stamps, frame numbers, or packet identifiers.

8. The method according to claim 7, further comprising the steps of:
decoding the first media data stream; and
decoding the second media data stream.

9. The method according to claim 8, further comprising the step of:
combining the first decoded media data stream and the second decoded media data stream to an enhanced decoded media data stream;

10. The method according to claim 1, further comprising the step of:
deleting at least the media data for one of the first or the second media data streams from a memory if the media data is no longer valid.

11. The method according to claim 1, wherein the second media data stream comprises model data for enhancing the resolution of the first media data stream when rendered.

12. The method according to claim 1, further comprising the step of:
retrieving data for the first media data stream and the second media data stream from at least a first medium; and
storing the first media data stream and the second media data stream on separate media.

13. The method according to claim 12, wherein the first media data stream is stored in a first memory, and the second media data stream is stored in a second memory.

14. The method according to claim 12, wherein the first media data stream is stored on a hard disc, and the second media data stream is stored on an optical disc, or vice versa.

15. The method according to claim 12, wherein the data for the first and the second media data streams are retrieved from separate first and second medium.

16. The method according to claim 12, wherein the data is retrieved from a signal received over a wireless or wire based transmission medium carrying the media data for the first and the second media data streams.

17. The method according to claim 12, wherein the step of retrieving data comprises the step of:
retrieving the first and second media data stream from a layered transmission stream received over a transmission medium.

18. The method according to claim 12, wherein the step of retrieving further comprises the step of:
encoding the retrieved media data into at least two associated layers being the first media data stream and the second media data stream.

19. Apparatus for handling a first media data stream and second media data stream having additional information related to the first media data stream, comprising:
means for retrieving media data for the first and the second media data media data stream; and
means for storing the media data of the first and the second media data streams on separate media.

20. The apparatus according to claim 19, wherein the apparatus further comprises:
means for encoding a media data stream into the first media data stream and the second media data stream.

21. Apparatus for handling a first media data stream and second media data stream having additional information related to the first media data stream, comprising:
means for retrieving media data for the first media data stream from a first medium; and
means for retrieving media data for the second media data stream from a second medium;

22. The apparatus according to claim 21, wherein the apparatus further comprises:
means for synchronizing the first and second media data streams;
means for decoding the first media data stream;
means for decoding the second media data stream; and
means for combining the decoded media data stream.

23. A computer readable medium having embodied thereon a computer program for processing by a computer, the computer program comprising:
a code segment for carrying out the method according to any of the claims 1-11 or the method according to any of the claims 12-18.
